(19) United States
(12) Patent Application Publication
(10) Pub. No.: US 2007/0263604 A1
(43) Pub. Date: Nov. 15, 2007

(54) Ring back notification system and method therefor

(76) Inventor: Yen-Po Tai, Taipei City (TW)

Correspondence Address: RABIN & Berdo, PC, 1101 14TH STREET, NW, SUITE 500, WASHINGTON, DC, 20005, US

(21) Appl. No.: 11/372,137

(22) Filed: Mar. 10, 2006

(51) Int. Cl. H04M 3/42; H04M 11/00; H04L 12/66

(52) U.S. Cl. 370/356; 379/201.07; 379/201.08; 379/100.12; 379/100.06; 379/207.05

(57) ABSTRACT

A system and method of ring back notification for the EP phone is provided. A caller and a receiver communicate in the IP network through the respective connected nodes. When the receiver's network is busy, a request message is sent to the server of the IP network. The server receives the request message of starting a ring back notification and sets a ring back notification tag. Afterwards, the network status of the receiver is detected recurrently. Once the receiver's network is detected to be idle, the ring back notification is sent to the server and then to the caller's node. The function of the ring back notification is to notify the caller that the receiver's network is idle after the receiver's busy status is over, so that the caller can communicate with the receiver in time.

### BACKGROUND OF THE INVENTION

1. Field of Invention

The invention relates to a mobile communication and, in particular, to a system and method of providing a ring back notification to the caller.

2. Related Art

With the development in communication technology, users of mobile communications are increasing exponentially and it becomes more often for people to use phones. The introduction of IP phones makes the communications much cheaper.

The IP phone is a new type of telephone system that uses the Internet as the transmission medium. It uses a voice compression algorithm to compress and encode the voice signals. These voice data are packaged according to the TCP/IP standard. They are then divided into different data packets by the network and sent to the destination. The receiver end re-assemblies the packets of these voice data to form a complete signal, which is then played by a phone receiver or speakers.

As people use the IP phones more often, they usually encounter some common problems. For example, the receiver is unavailable or on the phone. Therefore, the caller receives only a busy line tone or messages such as “please hold” and “the line is busy.” In the case of the receiver being unable to answer the phone, the phone companies provide a function of voice message. However, there is no good solution for the case when the receiver is communicating with other people. Therefore, the caller has to make another phone call later, but, sometimes, the receiver is still on the line. So, it is very inconvenient and troublesome for callers because they have to make a lot of effort and waste time to establish a connection with the receiver. For some companies, because of heavy loading of business phone calls their phone lines may always keep busy, such that the companies may miss some important phone calls or unable to call out, which led to business delays. It is thus important to avoid such problems in the modern highly efficient society.

### SUMMARY OF THE INVENTION

In view of the foregoing, an object of the invention is to provide a system and method of IP phone for providing a ring back notification. The caller may receive a notification after the receiver finishes a phone conversation with a third party. This can solve the problems existing in the prior art.

To achieve the above object, the disclosed ring back notification system for the IP phones is used when a caller is communicating with a receiver through nodes of IP network, including: a ring back request module, a ring back notification module, a server, and a detection module. The ring back request module is used to send a request message for starting a ring back notification when the receiver's network is busy. The ring back notification module sends out a ring back notification when the receiver's network is idle. The server in the IP network is used to receive the request message for starting the ring back notification, to set a ring back notification tag, and to send the ring back notification according to the ring back notification tag to the node of the caller. The detection module detects recurrently the status of the receiver's network.

In accord with the disclosed IP phone ring back notification system, the ring back notification tag is used to identify the caller's IP address. The server can thus guide the ring back notification to the caller's node in accordance with the caller's IP address.

The disclosed IP phone ring back notification system sends the ring back notification in the form of packets. The format of the packet includes a header, a source IP address, and order data. The header contains a specific hexadecimal code for identifying the type of the ring back notification packet. The source IP address is used to represent the caller's IP address. The order data record the classification information containing the IP addresses of those who have established call requests with the receiver. Besides, the IP addresses in the order data contain a priority order.

The disclosed IP phone ring back notification method includes the steps of: sending an call request message from the caller's node the caller connected to the receiver's node the receiver connected; sending a request message for starting a ring back notification to the server in the IP network when the receiver's network is busy; receiving the request message for starting a ring back notification and setting a ring back notification tag by the server; recurrently detecting the current status of the receiver's network; sending a ring back notification to the server when the receiver's network is detected in an idle status; and sending the ring back notification to the caller's node in accord with the ring back notification tag by the server.

In the disclosed IP phone ring back notification method, the ring back notification tag is used to identify the caller's IP address.

In accord with the disclosed IP phone ring back notification method, the ring back notification is transmitted in the format of packets. The format of the packets includes a header, a source IP address, and order data. The header contains a specific hexadecimal code for identifying the type of the ring back notification packet. The source IP address is used to represent the caller's IP address. The order data record the classification information containing the IP addresses of those who have established call requests with the receiver. The IP addresses in the order data contain a priority order. Besides, the server analyzes the ring back notification packets and compares the ring back notification tag with the source IP address in the ring back notification packets.

Therefore, the disclosed IP phone ring back notification system and method sends a notification to the caller with the ring back notification function immediately after the receiver finishes a phone conversation with a third party. The caller is thus notified that the receiver's network is currently idle, so that the caller make a communication with the receiver in time.

Moreover, the packet of the ring back notification contains an order field for prioritizing several callers that need to communicate with the receiver at the same time. A priority is associated with the IP address of each caller in order to avoid missing any important phone calls.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is a block diagram of the IP phone ring back notification system of present invention; and

FIG. 2 is a flowchart of the disclosed IP phone ring back notification method of present invention.

### DETAILED DESCRIPTION OF THE INVENTION

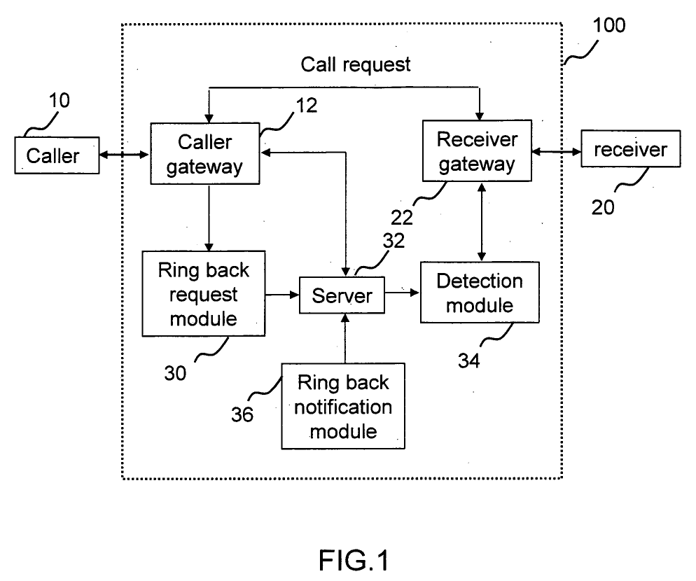

With reference to the block diagram of system shown in FIG. 1, the IP phone ring back notification system 100 includes a caller gateway 12, a receiver gateway 22, a ring back request module 30, a server 32, a detection module 34, and a ring back notification module 36. The caller gateway 12, that is the caller's node, connects with the caller 10. The receiver gateway 22, that is the receiver's node, connects with the receiver 20. The caller 10 and the receiver 20 communicate with each other through the respective connected nodes in the IP network. When the caller 10 wants to call the receiver 20, a call request message is sent from the caller's node 10 to the receiver's node 22.

When the network of the receiver 20 is busy, the caller 10 starts a selection of the ring back notification function. The caller gateway 12 sends out a command from the caller 10 to the ring back request module 30 for sending a request message for starting the ring back notification function. In this case, the ring back request module 30 sends out a request for starting the ring back notification function to the server 32 via the network. The server 32 starts the ring back notification function after receiving the request message. Then the IP address of the caller is set with a back ring notification tag and stored in the server 32. At the same time, the server 32 drives the detection module 34 to recurrently detect the current status of the receiver's network. Once the receiver's network is idle, the detection module 34 sends the detection result of the receiver's network being idle to the ring back notification module 36. The ring back notification module 36 then sends a ring back notification to the server 32. The ring back notification is transmitted in the format of packets. The format of the packets includes a header, a source IP address, and order data. The header contains a specific hexadecimal code for identifying the type of the ring back notification packet. The source IP address is used to represent the caller's IP address. The order data record the classification information containing the IP addresses of those who have established call requests with the receiver.

The server 32 receives the ring back notification packets sent by the ring back notification module 36 and analyzes the data packets, thus obtaining the source IP address corresponding to the caller's IP address. In addition, the server 32 follows the ring back notification tag stored therein to obtain the IP address of the caller who requests to start the ring back notification function. The source IP address of the data packets is then compared so as to correctly guide the ring back notification via the caller gateway 12 to the caller 10. The ring back notification data packets can be converted by a digital/analog converter of the caller 10 into an analog signal, and then presented in the form of rings, vibrations, text, voices, or flashes on the phone device of the caller 10.

In the case where several callers simultaneously call the same receiver 20, ring back notifications can be sent in sequence to all of the callers. As explained above, the ring back notification packets contain an order field for classifying the IP addresses of callers who want to establish call requests. Since all the data in the IP phone are digitized, therefore, the order field of the data packets can be inserted with priorities for the callers. That is, different IP phones are set with different levels of priority. For example, the priority order can be assigned according to a level of importance of the IP phones. Therefore, when the ring back notification data packets reach the server 32, the server 32 sends the ring back notification to the callers in accordance with the priority order in the order data, so the receiver 20 can select the caller with the highest priority.

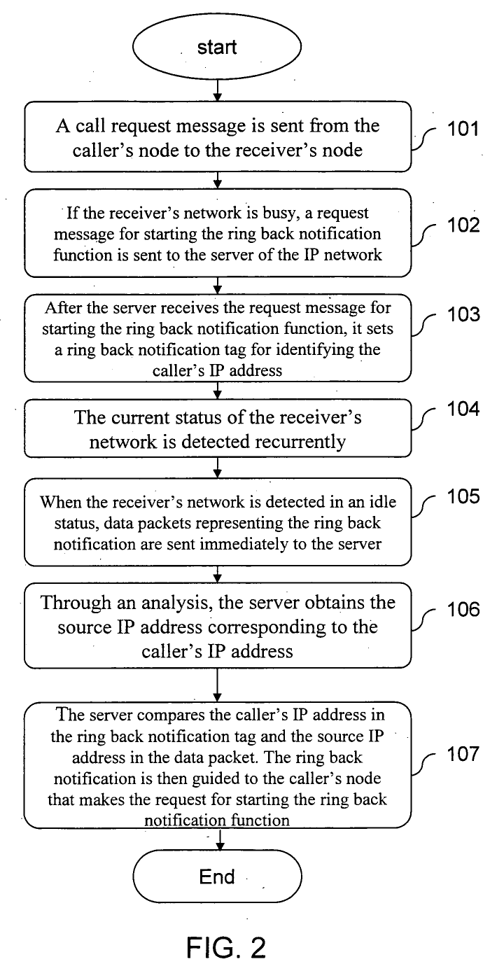

In the following, FIG. 2 is utilized to explain the disclosed IP phone ring back notification method. One caller and one receiver communicate with each other in the IP network through the respective connected nodes. As shown in the drawing, when the caller wants to communicate with the receiver, a call request message is sent from the caller's node to the receiver's node (step 101). If the receiver's network is busy, a request message for starting the ring back notification function is sent to the server of the IP network (step 102). Once the receiver finishes a phone conversation with a third party, the caller will receive a notification.

After the server receives the request message for starting the ring back notification function, it sets a ring back notification tag for identifying the caller's IP address (step 103). The current status of the receiver's network is detected recurrently (step 104). The detection can be performed at a specific time interval until the receiver is available for answering the phone call. When the receiver's network is detected in an idle status, data packets representing the ring back notification are sent immediately to the server (step 105). Then, the server analyzes the data packets of the received ring back notification. The format of the packet contains a header, a source IP address, and order data. The header contains a specific hexadecimal code for identifying the type of the ring back notification packet. The source IP address is used to represent the caller's IP address. The order data record the classification information containing the IP addresses of those who have established call requests with the receiver. Through the analysis, the server obtains the source IP address corresponding to the caller's IP address (step 106).

Afterwards, the server compares the caller's IP address in the ring back notification tag and the source IP address in the data packet. The ring back notification is then guided to the caller's node that makes the request for starting the ring back notification function (step 107).

In addition, when several callers simultaneously call the same receiver, the order data field in the packet of ring back notification is classified according to the IP addresses of all the callers having established call requests. A priority order is further assigned to the order data field of the packets. That is, different IP phones are associated with different levels of priority. Therefore, the server sends in order the ring back notification to the callers in accordance with the priority order in the order data field.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An IP phone ring back notification system with a caller and a receiver communicating with each other in an IP network through the respective connected nodes, the system comprising:
a ring back request module, which sends out a request message for starting a ring back notification function when the receiver's network is busy;
a ring back notification module, which sends out a ring back notification when the receiver's network is idle;
a server in the IP network, which is used to receive the request message for starting the ring back notification function, sets a ring back notification tag, and sends the ring back notification to the caller's node associated with the caller in accordance with the ring back notification tag; and
a detection module, which is used to recurrently detect the status of the receiver's network.

2. The IP phone ring back notification system of claim 1, wherein the ring back notification tag is used to identify the caller's IP address.

3. The IP phone ring back notification system of claim 1, wherein the server guides the ring back notification to the caller's node in accordance with the caller's IP address.

4. The IP phone ring back notification system of claim 1, wherein the ring back notification is transmitted in the form of packets, the packet containing:
a header, which contains a specific hexadecimal code for identifying the type of the ring back notification packet;
a source IP address, which is used to represent the IP address of the caller; and
order data, which record the classification information containing the IP addresses of those who have established call requests with the receiver.

5. The IP phone ring back notification system of claim 4, wherein the IP address classification in the order data contains a priority order

6. An IP phone ring back notification method with a caller and a receiver communicating with each other in an IP network through the respective connected nodes, the method comprising the steps of:
sending a call request message from a caller's node the caller connected to a receiver's node the receiver connected;
sending a request message for starting a ring back notification function to a server of the IP network when the receiver's network is busy;
receiving the request message for starting a ring back notification function by the server and setting a ring back notification tag;
detecting recurrently the status of the receiver's network;
sending a ring back notification to the server when the receiver's network is detected in an idle status; and
sending the ring back notification to the caller's node by the server in accordance with the ring back notification tag.

7. The IP phone ring back notification method of claim 6, wherein the ring back notification tag is used to identify the caller's IP address.

8. The IP phone ring back notification method of claim 6, wherein the ring back notification is transmitted in the form of packets, the packet containing:
a header, which contains a specific hexadecimal code for identifying the type of the ring back notification packet;
a source IP address, which identifies the IP address of the caller; and
order data, which record the classification information containing the IP addresses of those who have established call requests with the receiver.

9. The IP phone ring back notification method of claim 8 further comprising the step of setting a priority order for the IP addresses in the order data.

10. The IP phone ring back notification method of claim 8 further comprising the step of using the server to analyze the ring back notification packets and compare the ring back notification tag and the source IP address of the ring back notification packet.
